(19) United States
(12) Patent Application Publication
(10) Pub. No.: US 2026/0291737 A1
(43) Pub. Date: Sep. 24, 2026

(54) A METHOD FOR SECURE COMMUNICATION AND CONTROL BETWEEN A BLUETOOTH DEVICE, A MOBILE PHONE, AND A SERVER

(71) Applicant: HANGZHOU SYNOCHIP DATA SECURITY TECHNOLOGY CO., LTD, Hangzhou, Zhejiang (CN)

(72) Inventors: Haoran TANG, Hangzhou (CN); Hongchang LUO, Hangzhou (CN); Feifei ZHANG, Hangzhou (CN)

(73) Assignee: HANGZHOU SYNOCHIP DATA SECURITY TECHNOLOGY CO., LTD, Hangzhou, Zhejiang (CN)

(21) Appl. No.: 18/880,417

(22) PCT Filed: Oct. 31, 2023
(86) PCT No.: PCT/CN2023/128529

§ 371 Date: Dec. 31, 2024

(30) Foreign Application Priority Data
Apr. 25, 2023 (CN) 202310453610.6

(51) Int. Cl. H04L 9/32; H04W 12/50

(52) U.S. Cl. CPC H04L 9/321; H04W 12/50

(57) ABSTRACT

A method for secure communication and control between a Bluetooth device, a mobile phone, and a server, including: S1, the phone performs identity authentication on the server; S2, the phone registers with the server, and saves the server public key after successful registration; S3, the phone logs in to the server, which verifies the phone through the server private key to determine whether the phone is a legitimate operator; S4, the phone connects to the Bluetooth device, which is authenticated by the phone to the server. After authentication is successful, enters S5; S5, the phone performs control commands on the Bluetooth device, which verifies the control commands, and executes the commands after successful verification; S6, after the device is executed, the server verifies the legitimacy of the device. The invention solves the problem of identity authentication between mobile phones, Bluetooth devices and servers, and prevents other devices from malicious impersonation.

### TECHNICAL FIELD

The invention belongs to the field of security encryption and data communication technology, specifically relating to a method for secure communication and control between a Bluetooth device, a mobile phone, and a server.

### BACKGROUND TECHNOLOGY

Currently, using mobile phones to control smart homes or certain Internet of Things (IoT) devices through Bluetooth has gradually become a trend; however, there are several security issues and defects. Directly controlling Bluetooth devices with mobile phones poses difficulties in mutual identity authentication, and the communication and control information between the two can easily be maliciously intercepted and tampered with by others, posing significant security risks. At the same time, some Bluetooth devices do not integrate modules such as WiFi or 5G due to cost and performance considerations, and Bluetooth devices cannot transmit some of their own status information to backend servers.

Currently, face recognition unlocking, fingerprint recognition unlocking, finger vein recognition, and iris recognition unlocking all have certain shortcomings and limitations.
1. The fingerprint recognition module requires direct human contact, exposed devices not only consider health factors, but also the possibility of malicious film sticking;
2. The face recognition module requires to remove masks on most devices, without removing masks recognition algorithm in the pass rate and false recognition rate are not very ideal. In addition, face recognition rejection rate and false recognition rate are higher than fingerprint recognition;
3. The technology of finger vein recognition and iris recognition are not yet mature enough for large-scale use, especially in high-traffic situations;

So controlling the smart lock through a mobile phone is a good supplementary way. There is a method for controlling Bluetooth on mobile phones: 1. Establish a connection between a mobile phone and a Bluetooth device, and the mobile phone is ready to control the Bluetooth device. 2. The mobile phone sends control commands and information in plain text to the Bluetooth device. 3. The Bluetooth device responds to control commands. 4. Send the control result device information and its own status back to the mobile phone in plain text. 5. The mobile phone uploads the status of the device to the backend server. In step 1, there is no identity authentication between the mobile phone and the Bluetooth device, and anyone within the distance of Bluetooth communication can become the controller of the Bluetooth device. In Step 2, the control commands and communication information between the mobile phone and the Bluetooth device are easily intercepted or tampered with by others. In step 4 and 5, the process by which the Bluetooth device upload the status information to the server is easily intercepted and tampered with by others. That is, the direct control of Bluetooth devices by mobile phones has difficulties in mutual identity authentication, and there are significant security risks in the communication and control between the two. At the same time, certain Bluetooth devices do not integrate modules such as WiFi or 5G due to cost and performance considerations, and Bluetooth devices cannot transmit some of their own status information to backend servers.

### INVENTION CONTENT

The invention provides a solution to the problem of identity authentication between a mobile phone, a Bluetooth device, and a server to prevent malicious impersonation by other devices; The method for secure communication and control between a Bluetooth device, a mobile phone, and a server by changing the key during each login to strengthen the security of communication among the three.

The technical scheme adopted by the invention is:
A method for secure communication and control between a Bluetooth device, a mobile phone, and a server. The specific steps are as follows:
S1, The mobile phone performs identity authentication on the server, and after the identity authentication is successful, enters the step S2;
S2, The mobile phone registers with the server, and saves the public key of the server after successful registration;
S3, The mobile phone logs in to the server. The server verifies the mobile phone through the server private key to determine whether the mobile phone is a legitimate operator. If yes, enters the step S4;
S4, The mobile phone connects to the Bluetooth device, and the Bluetooth device is authenticated by the mobile phone to the server. After the authentication is successful, enters the step S5;
S5, The mobile phone performs control commands on the Bluetooth device, and the Bluetooth device verifies the control commands from the mobile phone, and executes the control commands after the verification is successful;
S6, After the Bluetooth device is executed, the server verifies the legitimacy of the Bluetooth device.

Further, before step S1, it also includes step S0, the server generates an asymmetric key (K_{b+}, K_{b-}), and registers its own digital certificate with CA by using its own public key K_{b+}; Bluetooth device stores Bluetooth device identifier S, Bluetooth device private key K_{c-} and server public key K_{b+}; The server stores Bluetooth device identifier S, Bluetooth device public key K_{C+}, and server private key K_{b-}. The mobile phone obtained the Bluetooth device identifier S.

Further, in step S1, the specific steps of the mobile phone to authenticate the identity of the server are as follows:
S11, The mobile phone obtains the server digital certificate from the CA and the server public key K_{b+} from the certificate;
S12, After obtaining the server public key K_{b+}, the mobile phone generates a random number NA and sends it to the server;
S13, The server generates random authentication information M_{B}, and sends the data to the mobile phone. Then M_{B} and N_{A} are spliced into data M_{B}∥N_{A}, and digitally digests the data M_{B}∥N_{A} to obtain H(M_{B}∥N_{A});
S14, Signs the server private key K_{b-} to obtain f(K_{b-}, H(M_{B}∥N_{A})), and sends it to the mobile phone;
S15, The mobile phone uses the server public key K_{b+} to decrypt the data and obtain H(M_{B}∥NA) , then obtains a digital digest of data M_{B}∥N_{A}, and compares it with H(M_{B}∥N_{A}). If the comparison is consistent, the mobile phone successfully authenticates the server.

Further, in step S2, the specific steps of the mobile phone to register with the server are as follows:
S21, The mobile phone sends a registration request to the server. Upon receiving the response, the mobile phone generates a login password R, then spliced the Bluetooth device identifier S, login password R and the mobile phone identifier D into data S∥R∥D, and encrypted the data S∥R∥D using the server public key K_{b+} to obtain f(K_{b+}, S∥R∥D). And the digital digest H(S∥R∥D) of the data S∥R∥D is encrypted to obtain f(K_{b+}, H(S∥R∥D)), then sends f(K_{b+}, S∥R∥D) and f(K_{b+}, H(S∥R∥D)) together to the server;
S22, After receiving the data, the server uses the server private key K_{b-} to decrypt and obtain the data S∥R∥D and H(S∥R∥D), and then extracts a digital digest from the data S∥R∥D and compares it with the received digital digest H(S∥R∥D). If the data is consistent, then verifies the legitimacy of S. If S is legitimate, the server stores data R and D, and associates with data S, agreeing the mobile phone to register as the legitimate operator of the Bluetooth device;
S23, After receiving the response from the server, the mobile phone knows that the registration is successful.

Further, in step S3, the specific steps of mobile phone login server are as follows:
S31, the mobile phone sends the login request and the mobile phone number to the server, and the server sends the short message service (SMS) verification code T after receiving it;
S32, After receiving the verification code T, the mobile phone generates the symmetric key Ka for communication. Then, the verification code T, login password R, mobile phone identifier D, and symmetric key Ka are combined into data T∥R∥D∥Ka. Then, encrypted the data T∥R∥D∥Ka using the server public key K_{b+} to obtain f(K_{b+}, T∥R∥D∥Ka). And the digital digest H(T∥R∥D∥Ka) of the data T∥R∥D∥Ka is encrypted to obtain f(K_{b+}, H(T∥R∥D∥Ka)), then sends f(K_{b+}, T∥R∥D∥Ka) and f(K_{b+}, H(T∥R∥D∥Ka)) together to the server;
S33, The server uses the server private key K_{b-} to decrypt and obtain the data T∥R∥D∥K and H(T∥R∥D∥Ka), and then extracts a digital digest from the data T∥R∥D∥Ka and compares it with the received digital digest H(T∥R∥D∥Ka). If the data is consistent, the server will verify the legality of the data T, R, D. If the verification passes, the server confirms that the mobile phone is the legitimate operator of the Bluetooth device.

Further, the server verifies that the mobile phone is a legitimate operator, the symmetric key Ka is used to encrypt and decrypt the communication with the mobile phone during the same login connection period.

Further, in step S4, the specific steps for Bluetooth device to be authenticated by mobile phone to server are as follows:
S41, the mobile phone sends the authentication request, the Bluetooth device first identifies the Bluetooth device as S after receiving the request, and encrypts the data using the server public key K_{b+} to obtain f(K_{b+}, S) and sends it to the mobile phone. The mobile phone receives the data and encrypts it using the symmetric key Ka to obtain f(Ka, f(K_{b+}, S)), and then sends it to the back-end server along with the device authentication request;
S42, The server uses the symmetric key Ka to decrypt and obtain the data f(K_{b+}, S), and then uses the server private key K_{b-} to decrypt and obtain the data S. Finally, the server verifies the legitimacy of the data S. If the verification is passed, the server generates the symmetric key Kt for communication between the server and the Bluetooth device during the login, and the symmetric key Ky for verification, and concatenates them to form the data Kt∥Ky. Then, the public key of the Bluetooth device K_{c+} is used to encrypt the data Kt∥Ky to obtain f(K_{c+}, Kt∥Ky). The private key of the server K_{b-} is used to encrypt and sign the data Kt∥Ky to obtain f(K_{b-}, Kt∥Ky). Then the data f(K_{b-}, Kt∥Ky) and f(K_{c+}, Kt∥Ky) are encrypted with the symmetric key Ka to obtain f(Ka, f(K_{b-}, Kt∥Ky)) and f(Ka, f(K_{c+}, Kt∥Ky)), and sends it to the mobile phone;
S43, the mobile phone uses the symmetric key Ka to decrypt and obtain the data f(K_{b-}, Kt∥Ky) and f(K_{c+}, Kt∥Ky), and sends the data to the Bluetooth device;

S44, the Bluetooth device uses the private key of the Bluetooth device K_{c-} to decrypt the data f(K_{c+}, Kt∥Ky) to obtain Kt∥Ky, and uses the public key of the server K_{b+} to decrypt the data f(K_{b-}, Kt∥Ky) to obtain Kt∥Ky, and compares the two decrypted data. If the comparison is consistent, the authentication is successful.

Further, after successful authentication between Bluetooth device and server, the Bluetooth device saves the symmetric key Kt for communication and the symmetric key Ky for verification as the symmetric key for communication and verification between Bluetooth device and server during the same login.

Further, the specific steps of step S5 are as follows:
S51, the mobile phone sends control commands to the Bluetooth device, the Bluetooth device generates a random number T after receiving the control command, and then encrypts the data T using the symmetric key Kt and sends the encrypted data f(Kt, T) to the mobile phone. After receiving the data, the mobile phone uses symmetric key Ka to encrypt and obtain f(Ka, f(Kt, T)), which is then sent to the server along with the control command;
S52, After receiving the data, the server first decrypts it using the symmetric key Ka to obtain the data f(Kt, T), and then decrypts the data using the symmetric key Kt to obtain the data T. After obtaining the random number T, the server first encrypts the data T using the symmetric key Ky to obtain the data f(Ky, T). Then, it takes a digital digest of the data f(Ky, T) to obtain H(f(Ky, T)). Finally, the symmetric key Ka is used to encrypt the digital digest to obtain f(Ka, H(f(Ky, T)) and sends it to the mobile phone;
S53, The mobile phone uses the symmetric key Ka to decrypt and obtain the data H(f(Ky, T)), and send it to the Bluetooth device. The Bluetooth device also encrypts the data T using the symmetric key Ky and extracts a digital digest to obtain H(f(Ky, T)). The generated data H(f(Ky, T)) is compared with the digital digest received from the mobile phone. If the comparison is consistent, the Bluetooth device executes the control command issued by the mobile phone.

Further, in step S6, the specific steps for the server to verify the legitimacy of Bluetooth device are as follows:

S61, the Bluetooth device encrypts its own state L and the digital digest H(L) of L through the symmetric key Kt to obtain f(Kt, L) and f(Kt, H(L)), and sends these data to the mobile phone;
S62, After receiving the data, the mobile phone encrypts them with the symmetric key Ka to obtain f(Ka, f(Kt, L)) and f(Ka, f(Kt, H(L))), and then sends f(Ka, f(Kt, L)) and f(Ka, f(Kt, H(L)) to the server. The server uses decryption to obtain the Bluetooth device status L and verify the legitimacy of the L.

The beneficial effects of the invention are: solving the problem of identity authentication between mobile phones, Bluetooth devices and servers, and preventing malicious impersonation by other devices; The key is changed during each login, which enhances the security of the communication between the three parties.

### BRIEF DESCRIPTION OF THE DRAWINGS

FIG. 1 is a device state diagram of the invention.

FIG. 2 is a flow chart of the mobile phone verifying the identity of the server of the invention.

FIG. 3 is a flow chart of the mobile phone registering with the server of the invention.

FIG. 4 is a flow chart of the mobile phone login server of the invention.

FIG. 5 is a flow chart of authentication between the Bluetooth device and the server of the invention.

FIG. 6 is a flow chart of the mobile phone controlling the Bluetooth device of the invention.

### SPECIFIC IMPLEMENTATION METHOD

The invention is further explained in conjunction with specific embodiments; however, the invention is not limited to these specific embodiments. Technicians in this field should recognize that the invention covers all alternatives, improvements, and equivalents that may be included within the scope of the claims.

### Terminology Explanation

Symmetric encryption: The encryption method that uses a single key cryptosystem, the same key can be used as the encryption and decryption of information at the same time, this encryption method is called symmetric encryption.

Asymmetric encryption: Unlike symmetric encryption algorithms, asymmetric encryption algorithms require two keys, namely the publickey and the privatekey. The publickey and the privatekey are a pair. If the publickey is used to encrypt data, only the corresponding privatekey can be used to decrypt the data. If data is encrypted with a privatekey, it can only be decrypted with the corresponding publickey.

Digital digest: Digital digest technology is the method that use of one-way Hash function to map the plaintext input of any length to ciphertext output of a fixed length (such as 128bit), ensuring the integrity of information, and avoiding information in the process of network transmission tampered with or partially deleted.

Digital signature: A digital signature (also known as a publickey digital signature) is a string of numbers that can only be generated by the sender of information and cannot be forged by others. This string is also an effective proof of the authenticity of the information sent by the sender. It is a method of identifying digital information that is similar to an ordinary physical signature written on paper, but implemented using techniques from the field of publickey cryptography. A set of digital signatures typically defines two complementary operations, one for signature and the other for verification. Digital signature is the application of asymmetric key encryption technology and digital digest technology.

CA Digital Certificates: The CA Center is a nationally recognized authoritative, trusted and impartial third-party organization that is responsible for issuing and managing the digital certificates required by all entities involved in online business. Digital certificates are the identity cards of the online world. It is possible to establish a secure and reliable trust relationship for users who do not meet each other in the online world. The establishment of such trust relationship comes from the PKI/CA authentication center, and building a secure PKI/CA authentication center is crucial. The CA has a certificate (containing a publickey) and a privatekey. Public users on the Internet trust the CA by verifying its signature. Anyone can obtain a CA certificate (including a publickey) to verify the certificate issued by the CA.

Bluetooth: Bluetooth technology is an open global specification for wireless data and voice communication, it is based on low-cost near field wireless connection, a special near field wireless technology connection for fixed and mobile devices to establish a communication environment.

Function symbol: f(U, V) is to encrypt data V using the key U; H(W) is to obtain a digital digest of the data W; X∥Y is to splice the data X and data Y into a new data.

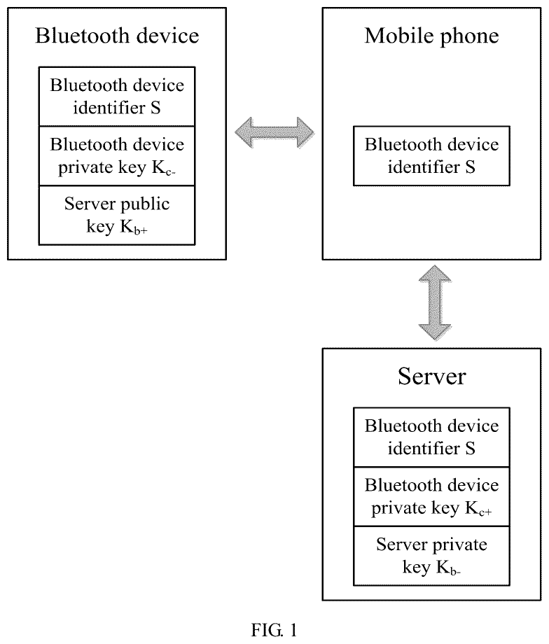

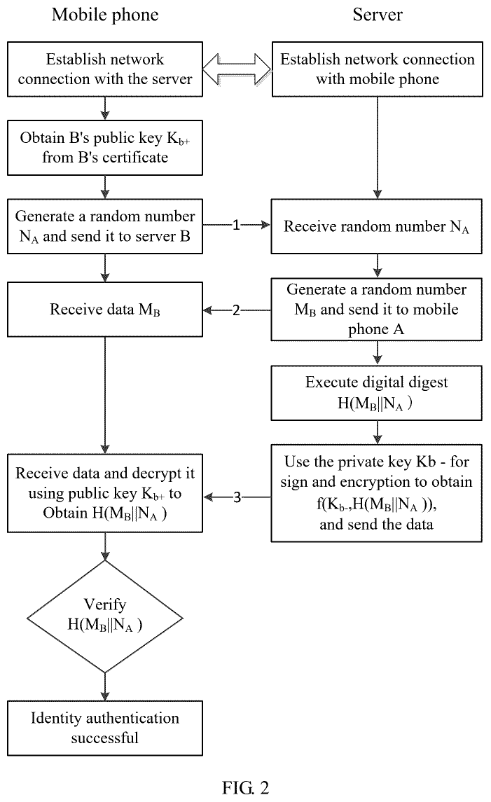

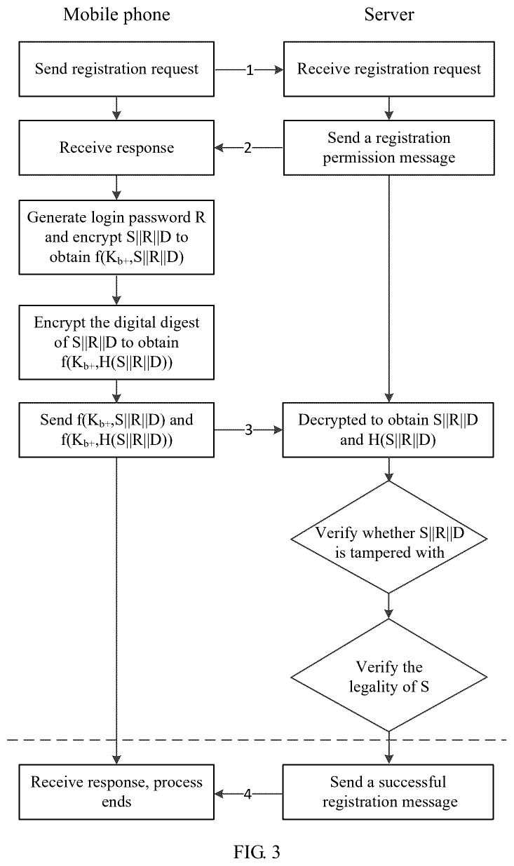

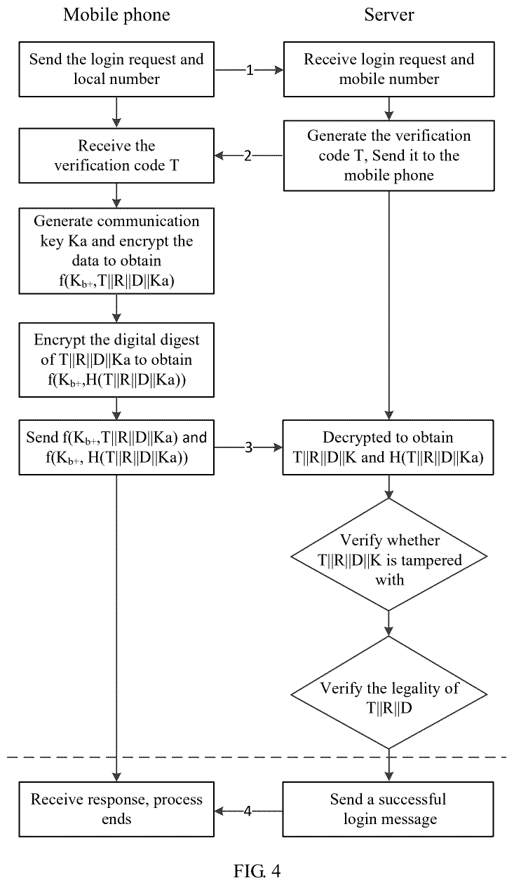

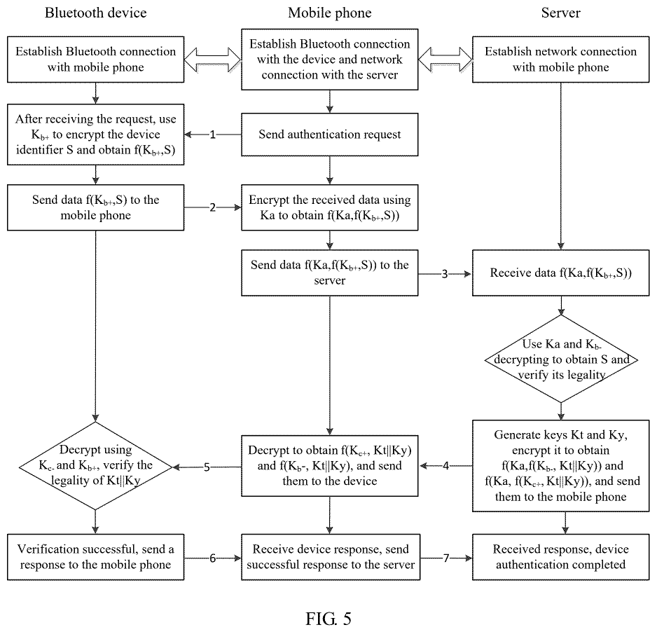

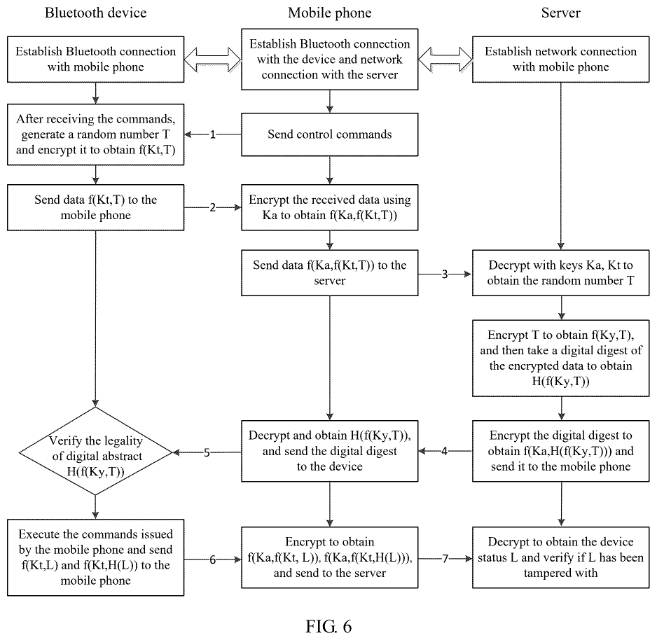

Referring to FIG. 1-6, this embodiment provides a method for secure communication and control between a Bluetooth device, a mobile phone, and a server. The specific steps are as follows:

S0, the server generates an asymmetric key (K_{b+}, K_{b-}), and registers its own digital certificate with CA by using its own public key K_{b+}. Bluetooth device stores Bluetooth device identifier S, Bluetooth device private key K_{c-} and server public key K_{b+}; The server stores Bluetooth device identifier S, Bluetooth device public key K_{c+}, and server private key K_{b-}. The mobile phone obtained the Bluetooth device identifier S.

Bluetooth devices and servers are generally provided by the same manufacturer, so at the factory, Bluetooth devices and servers have been stored in the corresponding identifiers and keys. As the owner of the Bluetooth device, the mobile phone has obtained the Bluetooth device identifier S from the manufacturer. The Bluetooth device identifier S is unique.

S1, The mobile phone performs identity authentication on the server, and after the identity authentication is successful, enters the step S2;

The specific steps of the mobile phone to authenticate the identity of the server are as follows:
S11, The mobile phone obtains the server digital certificate from the CA and the server public key K_{b+} from the certificate;
S12, After obtaining the server public key K_{b+}, the mobile phone generates a random number NA and sends it to the server;
S13, The server generates random authentication information M_{B}, and sends the data to the mobile phone. Then M_{B} and N_{A} are spliced into data M_{B}∥N_{A}, and the data M_{B}∥N_{A} is digitally summarized to get H(M_{B}∥N_{A});
S14, Signs the server private key K_{b-} to obtain f(K_{b-}, H(M_{B}∥N_{A})), and sends it to the mobile phone;
S15, The mobile phone uses the server public key K_{b+} to decrypt H(M_{B}∥N_{A}), then obtains a digital digest of data M_{B}∥N_{A}, and compares it with H(M_{B}∥N_{A}). If the comparison is consistent, the mobile phone successfully authenticates the server.
S2, The mobile phone registers with the server, and saves the server public key K_{b+} after successful registration;

The specific steps of the mobile phone to register with the server are as follows:
S21, The mobile phone sends a registration request to the server. Upon receiving the response, the mobile phone generates a login password R, then spliced the Bluetooth device identifier S, login password R and the mobile phone identifier D into data S∥R∥D, and encrypted the data S∥R∥D using the server public key K_{b+} to obtain f(K_{b+}, S∥R∥D). And the digital digest H(S∥R∥D) of the data S∥R∥D is encrypted to obtain f(K_{b+}, H(S∥R∥D)), then sends f(K_{b+}, S∥R∥D) and f(K_{b+}, H(S∥R∥D)) together to the server;
S22, After receiving the data, the server uses the server private key K_{b-} to decrypt and obtain the data S∥R∥D and H(S∥R∥D), and then extracts a digital digest from the data S∥R∥D and compares it with the received digital digest H(S∥R∥D). If the data is consistent, then verifies the legitimacy of S. If S is legitimate, the server stores data R and D, and associates with data S, agreeing the mobile phone to register as the legitimate operator of the Bluetooth device;
S23, After receiving the response from the server, the mobile phone knows that the registration is successful.
S3, The mobile phone logs in to the server. The server verifies the mobile phone through the server private key K_{b-} to determine whether the mobile phone is a legitimate operator. If yes, enters the step S4;

The specific steps of mobile phone login server are as follows:
S31, the mobile phone sends the login request and the mobile phone number to the server, and the server sends the short message service (SMS) verification code T after receiving it;
S32, After receiving the verification code T, the mobile phone generates the symmetric key Ka for communication. Then, the verification code T, login password R, mobile phone identifier D, and symmetric key Ka are combined into data T∥R∥D∥Ka. Then, encrypted the data T∥R∥D∥Ka using the server public key K_{b+} to obtain f(K_{b+}, T∥R∥D∥Ka). And the digital digest H(T∥R∥D∥Ka) of the data T∥R∥D∥Ka is encrypted to obtain f(K_{b+}, H(T∥R∥D∥Ka)), then sends f(K_{b+}, T∥R∥D∥Ka) and f(K_{b+}, H(T∥R∥D∥Ka)) together to the server; The mobile phone identifier D is unique.
S33, The server uses the server private key K_{b-} to decrypt and obtain the data T∥R∥D∥K and H(T∥R∥D∥Ka), and then extracts a digital digest from the data T∥R∥D∥Ka and compares it with the received digital digest H(T∥R∥D∥Ka) (prevent data tampering). If the data is consistent, the server will verify the legality of the data T, R, D. If the verification passes, the server confirms that the mobile phone is the legitimate operator of the Bluetooth device.

After verifying that the mobile phone is a legitimate operator, the server uses the symmetric key Ka to encrypt and decrypt the communication with the mobile phone during the same login connection.
S4, The mobile phone connects to the Bluetooth device, and the Bluetooth device is authenticated by the mobile phone to the server. After the authentication is successful, enters the step S5.

The specific steps for the Bluetooth device to be authenticated by the mobile phone to the server are as follows:
S41, the mobile phone sends the authentication request, the Bluetooth device first identifies the Bluetooth device as S after receiving the request, and encrypts the data using the server public key K_{b+} to obtain f(K_{b+}, S) and sends it to the mobile phone. The mobile phone receives the data and encrypts it using the symmetric key Ka to obtain f(Ka, f(K_{b+}, S)), and then sends it to the back-end server along with the device authentication request;
S42, The server uses the symmetric key Ka to decrypt and obtain the data f(K_{b+}, S), and then uses the server private key K_{b-} to decrypt and obtain the data S. Finally, the server verifies the legitimacy of the data S. If the verification is passed, the server generates the symmetric key Kt for communication between the server and the Bluetooth device during the login, and the symmetric key Ky for verification, and concatenates them to form the data Kt∥Ky. Then, the public key of the Bluetooth device K_{c+} is used to encrypt the data Kt∥Ky to obtain f(K_{c+}, Kt∥Ky). The private key of the server K_{b-} is used to encrypt and sign the data Kt∥Ky to obtain f(K_{b-}, Kt∥Ky). Then the data f(K_{b-}, Kt∥Ky) and f(K_{c+}, Kt∥Ky) are encrypted with the symmetric key Ka to obtain f(Ka, f(K_{b-}, Kt∥Ky)) and f(Ka, f(K_{c+}, Kt∥Ky)), and sends it to the mobile phone;
S43, the mobile phone uses the symmetric key Ka to decrypt and obtain the data f(K_{b-}, Kt∥Ky) and f(K_{c+}, Kt∥Ky), and sends the data to the Bluetooth device;
S44, the Bluetooth device uses the private key of the Bluetooth device K_{c-} to decrypt the data f(K_{c+}, Kt∥Ky) to obtain Kt∥Ky, and uses the public key of the server K_{b+} to decrypt the data f(K_{b-}, Kt∥Ky) to obtain Kt∥Ky, and compares the two decrypted data. If the comparison is consistent, the authentication is successful.

After successful authentication between the Bluetooth device and the server, the Bluetooth device saves the symmetric key Kt for communication and the symmetric key Ky for authentication as the symmetric key for communication and authentication between the Bluetooth device and the server during the same login period.
S5, The mobile phone performs control commands on the Bluetooth device, and the Bluetooth device verifies the control commands from the mobile phone, and executes the control commands after the verification is successful;

The specific steps are as follows:
S51, the mobile phone sends control commands to the Bluetooth device, the Bluetooth device generates a random number T after receiving the control command, and then encrypts the data T using the symmetric key Kt and sends the encrypted data f(Kt, T) to the mobile phone. After receiving the data, the mobile phone uses symmetric key Ka to encrypt and obtain f(Ka, f(Kt, T)), which is then sent to the server along with the control command;
S52, After receiving the data, the server first decrypts it using the symmetric key Ka to obtain the data f(Kt, T), and then decrypts the data using the symmetric key Kt to obtain the data T. After obtaining the random number T, the server first encrypts the data T using the symmetric key Ky to obtain the data f(Ky, T). Then, it takes a digital digest of the data f(Ky, T) to obtain H(f(Ky, T)). Finally, the symmetric key Ka is used to encrypt the digital digest to obtain f(Ka, H(f(Ky, T)) and sends it to the mobile phone;
S53, The mobile phone uses the symmetric key Ka to decrypt and obtain the data H(f(Ky, T)), and send it to the Bluetooth device. The Bluetooth device also encrypts the data T using the symmetric key Ky and extracts a digital digest to obtain H(f(Ky, T)). The generated data H(f(Ky, T)) is compared with the digital digest received from the mobile phone. If the comparison is consistent, the Bluetooth device executes the control command issued by the mobile phone.
S6, After the Bluetooth device is executed, the server verifies the legitimacy of the Bluetooth device.

The specific steps for the server to verify the legitimacy of Bluetooth device are as follows:
S61, the Bluetooth device encrypts its own state L and the digital digest H(L) of L through the symmetric key Kt to obtain f(Kt, L) and f(Kt, H(L)), and sends these data to the mobile phone;
S62, After receiving the data, the mobile phone encrypts them with the symmetric key Ka to obtain f(Ka, f(Kt, L)) and f(Ka, f(Kt, H(L))), and then sends f(Ka, f(Kt, L)) and f(Ka, f(Kt, H(L)) to the server. The server uses decryption to obtain the Bluetooth device status L and verify the legitimacy of the L (whether it has been tampered with).

The invention solves the problem of identity authentication between mobile phones, Bluetooth devices and servers, and prevents other devices from malicious impersonation; The key is changed during each login, which enhances the security of the communication between the three parties.

1. A method for secure communication and control between a Bluetooth device, a mobile phone, and a server, the specific steps are as follows:
S1, The mobile phone performs identity authentication on the server, and after the identity authentication is successful, enters the step S2;
S2, The mobile phone registers with the server, and saves the server public key after successful registration;
S3, The mobile phone logs in to the server. The server verifies the mobile phone through the server private key to determine whether the mobile phone is a legitimate operator. If yes, enters the step S4;
S4, The mobile phone connects to the Bluetooth device, and the Bluetooth device is authenticated by the mobile phone to the server. After the authentication is successful, enters the step S5;
S5, The mobile phone performs control commands on the Bluetooth device, and the Bluetooth device verifies the control commands from the mobile phone, and executes the control commands after the verification is successful;
S6, After the Bluetooth device is executed, the server verifies the legitimacy of the Bluetooth device.

2. According to the method of secure communication and control between a Bluetooth device, a mobile phone, and a server mentioned in claim 1, its characteristics are as follows: before step S1, it also includes step S0, the server generates an asymmetric key (K_{b+}, K_{b-}), and registers its own digital certificate with CA by using its own public key K_{b+}; Bluetooth device stores Bluetooth device identifier S, Bluetooth device private key Kc-and server public key K_{b+}; The server stores Bluetooth device identifier S, Bluetooth device public key K_{c+}, and server private key K_{b-}. The mobile phone obtained the Bluetooth device identifier S.

3. According to the method of secure communication and control between a Bluetooth device, a mobile phone, and a server mentioned in claim 2, its characteristics are as follows: In step S1, the specific steps of the mobile phone to authenticate the identity of the server are as follows:
S11, The mobile phone obtains the server digital certificate from the CA and the server public key K_{b+} from the certificate;
S12, After obtaining the server public key K_{b+}, the mobile phone generates a random number NA and sends
S13, The server generates random authentication information M_{B}, and sends the data to the mobile phone. Then M_{B} and N_{A} are spliced into data M_{B}∥N_{A}, and digitally digests the data M_{B}∥N_{A} to obtain H(M_{B}∥N_{A});
S14, Signs the server private key K_{b-} to obtain f(K_{b-}, H(M_{B}∥N_{A})), and sends it to the mobile phone;
S15, The mobile phone uses the server public key K_{b+} to decrypt the data and obtain H(M_{B}∥N_{A}), then obtains a digital digest of data M_{B}∥N_{A}, and compares it with H(M_{B}∥N_{A}). If the comparison is consistent, the mobile phone successfully authenticates the server.

4. According to the method of secure communication and control between a Bluetooth device, a mobile phone, and a server mentioned in claim 3, its characteristics are as follows: In step S2, the specific steps of the mobile phone to register with the server are as follows:
S21, The mobile phone sends a registration request to the server. Upon receiving the response, the mobile phone generates a login password R, then spliced the Bluetooth device identifier S, login password R and the mobile phone identifier D into data S∥R∥D, and encrypted the data S∥R∥D using the server public key K_{b-} to obtain f(K_{b+}, S∥R∥D). And the digital digest H(S∥R∥D) of the data S∥R∥D is encrypted to obtain f(K)_{b+}, H(S∥R∥D)), then sends f(K_{b+}, S∥R∥D) and f(K_{b+}, H(S∥R∥D)) together to the server;
S22, After receiving the data, the server uses the server private key K_{b-} to decrypt and obtain the data S∥R∥D and H(S∥R∥D), and then extracts a digital digest from the data S∥R∥D and compares it with the received digital digest H(S∥R∥D). If the data is consistent, then verifies the legitimacy of S. If S is legitimate, the server stores data R and D, and associates with data S, agreeing the mobile phone to register as the legitimate operator of the Bluetooth device;
S23, After receiving the response from the server, the mobile phone knows that the registration is successful.

5. According to the method of secure communication and control between a Bluetooth device, a mobile phone, and a server mentioned in claim 4, its characteristics are as follows: In Step S3, the specific steps of mobile phone login server are as follows:
S31, the mobile phone sends the login request and the mobile phone number to the server, and the server sends the short message service (SMS) verification code T after receiving it;
S32, After receiving the verification code T, the mobile phone generates the symmetric key Ka for communication. Then, the verification code T, login password R, mobile phone identifier D, and symmetric key Ka are combined into data T∥R∥D∥Ka. Then, encrypted the data T∥R∥D∥Ka using the server public key K_{b+} to obtain f(K_{b+}, T∥R∥D∥Ka). And the digital digest H(T∥R∥D∥Ka) of the data T∥R∥D∥Ka is encrypted to obtain f(K_{b+}, H(T∥R∥D∥Ka)), then sends f(K_{b+}, T∥R∥D∥Ka) and f(K_{b+}, H(T∥R∥D∥Ka)) together to the server;
S33, The server uses the server private key K_{b-} to decrypt and obtain the data T∥R∥D∥K and H(T∥R∥D∥Ka), and then extracts a digital digest from the data T∥R∥D∥Ka and compares it with the received digital digest H(T∥R∥D∥Ka). If the data is consistent, the server will verify the legality of the data T, R, D. If the verification passes, the server confirms that the mobile phone is the legitimate operator of the Bluetooth device.

6. According to the method of secure communication and control between a Bluetooth device, a mobile phone, and a server mentioned in claim 5, its characteristics are as follows: the server verifies that the mobile phone is a legitimate operator, the symmetric key Ka is used to encrypt and decrypt the communication with the mobile phone during the same login connection period.

7. According to the method of secure communication and control between a Bluetooth device, a mobile phone, and a server mentioned in claim 6, its characteristics are as follows: In step S4, the specific steps for Bluetooth device to be authenticated by mobile phone to server are as follows: S41, the mobile phone sends the authentication request, the Bluetooth device first identifies the Bluetooth device as S after receiving the request, and encrypts the data using the server public key K_{b+} to obtain f(K_{b+}, S) and sends it to the mobile phone. The mobile phone receives the data and encrypts it using the symmetric key Ka to obtain f(Ka, f(K_{b+}, S)), and then sends it to the back-end server along with the device authentication request;
S42, The server uses the symmetric key Ka to decrypt and obtain the data f(K_{b+}, S), and then uses the server private key K_{b-} to decrypt and obtain the data S. Finally, the server verifies the legitimacy of the data S. If the verification is passed, the server generates the symmetric key Kt for communication between the server and the Bluetooth device during the login, and the symmetric key Ky for verification, and concatenates them to form the data Kt∥Ky. Then, the public key of the Bluetooth device K_{c+} is used to encrypt the data Kt∥Ky to obtain f(K_{c+}, Kt∥Ky). The private key of the server K_{b-} is used to encrypt and sign the data Kt∥Ky to obtain f(K_{b-}, Kt∥Ky). Then the data f(K_{b-}, Kt∥Ky) and f(K_{c+}, Kt∥Ky) are encrypted with the symmetric key Ka to obtain f(Ka, f(K_{b-}, Kt∥Ky)) and f(Ka, f(K_{c+}, Kt∥Ky)), and sends it to the mobile phone;
S43, the mobile phone uses the symmetric key Ka to decrypt and obtain the data f(K_{b-}, Kt∥Ky) and f(K_{c+}, Kt∥Ky), and sends the data to the Bluetooth device;
S44, the Bluetooth device uses the private key of the Bluetooth device K_{c-} to decrypt the data f(K_{c+}, Kt∥Ky) to obtain Kt∥Ky, and uses the public key of the server K_{b+} to decrypt the data f(K_{b-}, Kt∥Ky) to obtain Kt∥Ky, and compares the two decrypted data. If the comparison is consistent, the authentication is successful.

8. According to the method of secure communication and control between a Bluetooth device, a mobile phone, and a server mentioned in claim 7, its characteristics are as follows: after successful authentication between Bluetooth device and server, the Bluetooth device saves the symmetric key Kt for communication and the symmetric key Ky for verification as the symmetric key for communication and verification between Bluetooth device and server during the same login.

9. According to the method of secure communication and control between a Bluetooth device, a mobile phone, and a server mentioned in claim 8, its characteristics are as follows: the specific steps of step S5 are as follows:
S51, the mobile phone sends control commands to the Bluetooth device, the Bluetooth device generates a random number T after receiving the control command, and then encrypts the data T using the symmetric key Kt and sends the encrypted data f(Kt, T) to the mobile phone. After receiving the data, the mobile phone uses symmetric key Ka to encrypt and obtain f(Ka, f(Kt, T)), which is then sent to the server along with the control command;
S52, After receiving the data, the server first decrypts it using the symmetric key Ka to obtain the data f(Kt, T), and then decrypts the data using the symmetric key Kt to obtain the data T. After obtaining the random number T, the server first encrypts the data T using the symmetric key Ky to obtain the data f(Ky, T). Then, it takes a digital digest of the data f(Ky, T) to obtain H(f(Ky, T)). Finally, the symmetric key Ka is used to encrypt the digital digest to obtain f(Ka, H(f(Ky, T)) and sends it to the mobile phone;
S53, The mobile phone uses the symmetric key Ka to decrypt and obtain the data H(f(Ky, T)), and send it to the Bluetooth device. The Bluetooth device also encrypts the data T using the symmetric key Ky and extracts a digital digest to obtain H(f(Ky, T)). The generated data H(f(Ky, T)) is compared with the digital digest received from the mobile phone. If the comparison is consistent, the Bluetooth device executes the control command issued by the mobile phone.

10. According to the method of secure communication and control between a Bluetooth device, a mobile phone, and a server mentioned in claim 9, its characteristics are as follows: In step S6, the specific steps for the server to verify the legitimacy of Bluetooth device are as follows:
S61, the Bluetooth device encrypts its own state L and the digital digest H(L) of L through the symmetric key Kt to obtain f(Kt, L) and f(Kt, H(L)), and sends these data to the mobile phone;
S62, After receiving the data, the mobile phone encrypts them with the symmetric key Ka to obtain f(Ka, f(Kt, L)) and f(Ka, f(Kt, H(L))), and then sends f(Ka, f(Kt, L)) and f(Ka, f(Kt, H(L)) to the server. The server uses decryption to obtain the Bluetooth device status L and verify the legitimacy of the L.
